(19) United States
(12) Patent Application Publication
(10) Pub. No.: US 2018/0326359 A1
(43) Pub. Date: Nov. 15, 2018

(54) Layered Membrane and Methods of Preparation Thereof

(71) Applicant: Aspen Products Group, Inc., Marlborough, MA (US)

(72) Inventors: Mark D. Fokema, Northborough, MA (US); Decio Coutinho, Marlborough, MA (US)

(73) Assignee: Aspen Products Group, Inc., Marlborough, MA (US)

(21) Appl. No.: 15/979,516

(22) Filed: May 15, 2018

Related U.S. Application Data
(60) Provisional application No. 62/506,532, filed on May 15, 2017.

(51) Int. Cl. B01D 65/08; B01D 69/12; B01D 69/02; B01D 67/00; B01D 71/02; B01D 71/28; B01D 71/42; B01D 71/26; B01D 71/62; C02F 1/44

(52) U.S. Cl. CPC B01D 65/08; C02F 2303/20; B01D 69/02; B01D 67/0009; B01D 67/0079; B01D 67/0095; B01D 71/024; B01D 71/28; B01D 71/42; B01D 71/26; B01D 71/62; C02F 1/44; B01D 2325/42; B01D 2325/14; B01D 2325/16; B01D 69/12

(57) ABSTRACT

A membrane for purifying a liquid stream includes a porous substrate and alternating layers of positively charged material and negatively charged material adhered to the porous substrate, wherein at least two of the layers of charged materials possess free ion exchange capacity.

### RELATED APPLICATION

This application claims the benefit of U.S. Provisional Application No. 62/506,532, filed 15 May 2017, the entire content of which is incorporated herein by reference.

### GOVERNMENT SUPPORT

The invention was supported, in whole or in part, by a grant under Contract No. EP-D-16-001, awarded by the United States Environmental Protection Agency. The Government has certain rights in the invention.

### BACKGROUND

The removal of ionic and non-ionic contaminants from water using semipermeable membranes has been practiced for a considerable time. Although a variety of membrane processes can be used to remove high-molecular-weight contaminants, removal of contaminants with molecular weights below 1000 Dalton is typically accomplished by nanofiltration (NF), reverse osmosis (RO), or forward osmosis (FO) processes. In each case, in order to produce higher-purity water, energy is supplied to the system in order to increase the chemical potential of the product water. In NF and RO, the driving force for purified water production arises from the high-pressure feed, which exceeds the osmotic pressure of the feed stream, and enables water to permeate from the low chemical potential feed stream through the membrane to the higher-chemical-potential purified-water product stream. In FO, the feed stream is not pressurized, and water permeates from the low chemical potential feed stream through the membrane into an even-lower-chemical-potential draw stream. The energy required to produce the purified water stream is input into the secondary step of separating the water from the draw stream.

The membranes used in NF, RO and FO processes usually consist of a thin hydrophilic active polymer layer supported on a porous substrate layer, with the active layer typically comprising polyamide, cellulose acetate, or polyethersulfone. Under an energy gradient, water molecules pass through the membrane by sequential displacement of one another in the voids between the polymer chains. Non-ionic solutes are unable to pass through the membrane because they are too large to pass through the voids or pores in the membrane. Ionic solutes are similarly unable to pass through the membrane dues to size exclusion, and may also be rejected via charged-based mechanisms.

The high capital and operating costs of current NF, RO and FO processes inhibit their widespread use. However, significantly reduced costs can be realized through the use of higher-permeability membranes with equivalent or improved solute rejection characteristics. In NF and RO processes, increased permeability enables the use of a smaller membrane area and lower feed pressure for a given application, thereby reducing system capital and operating costs. In FO processes, increased permeability reduces capital costs. In NF processes, where hardness rejection is the objective, it is beneficial to have high divalent salt rejection, but low monovalent salt rejection, so that the osmotic pressure difference between the feed and permeate streams is reduced and a lower feed pressure can be used to drive the process.

Fouling of membrane surfaces with organic, inorganic, colloidal, and biological species leads to a decrease in membrane-system performance, primarily in the form of reduced permeate flux due to increased hydraulic resistance, but also through increased membrane-module pressure drop, lower solute rejection, and even deterioration of the membrane polymer or module construction materials. Removal of foulants from membrane surfaces through backwashing or chemical treatments can be an effective, albeit disruptive, approach to maintaining acceptable membrane system performance; but, at a certain point, membrane replacement may become the only means of recovering desired performance levels.

Membrane fouling can be controlled to some degree through the manipulation of membrane element operating conditions, including hydrodynamics, operating pressure, pretreatment of the feed solution, and by using membranes with different surface properties. Key surface properties shown to impact fouling rates include hydrophilicity/hydrophobicity, membrane surface charge, surface roughness, and antimicrobial properties. Hydrophilic surfaces have been shown to be more resistant to fouling than hydrophobic surfaces due to their ability to form hydrogen bonds with water molecules and thereby form a thin water boundary layer between the hydrophilic surface and the bulk solution. Membrane surface charge affects fouling through electrostatic attraction and repulsion mechanisms. Thus, the nature of the feed solution dictates what type of membrane surface charge will help resist fouling, with negative surface charges enhancing fouling resistance with feeds containing negatively charged species, such as organic acids or proteins, and membranes with positive surface charges commonly used with solutions containing positively charged species, such as proteins. Surface roughness generally reduces membrane fouling resistance, as a rough membrane surface has a larger surface area for foulant adhesion, and it can also be more difficult to remove foulants from pits or crevices in the membrane surface during cleaning.

The stability of RO, NF, and FO membranes in the presence of oxidants, such as chlorine and ozone, can be problematic. Although cellulosic membranes are tolerant of chlorine, the low water flux, low salt rejection, limited operable pH range, and low upper operating temperature limit restricts the widespread use of cellulosic membranes. The more-commonly employed interfacially polymerized polyamide-based thin film membranes are very susceptible to oxidant degradation, which can lead to a doubling in salt passage after exposure to as little as 1,000 parts per million·hours (ppmh) Cl. Amide bond cleavage, loss of interchain hydrogen bonding, and membrane embrittlement have been proposed as mechanisms for membrane degradation upon oxidant exposure.

Membranes based upon multiple layers of polyelectrolytes deposited on porous substrates have been proposed as alternatives to thin film composite membranes for RO, NF and FO applications. These membranes are commonly formed via a layer-by-layer approach that uses alternating adsorption of cationic and anionic polyelectrolytes to build up a layered membrane structure. The polyelectrolytes are typically applied by immersing a substrate in the polyelectrolyte solution, followed by rinsing off excess and weakly associated polymer chains to leave a thin coating. Each deposition cycle adds a layer of polymer via electrostatic forces to the oppositely charged surface and reverses the surface charge, thereby readying the film for the addition of the next polymer layer. Films prepared in this manner tend to be uniform, follow the contours of the substrate, and may be from several nm to several microns thick.

As described by Michel, et al., ISRN Materials Science 701695 (2012), a variety of mechanisms come into play in the adhesion of the adsorbing polyelectrolyte to the previously deposited polyelectrolyte layer. Not only is there an enthalpic interaction associated with interactions between point charges on the oppositely charged polyelectrolyte chains, but also entropic effects occur due to polymer chain dehydration, conformational changes, and the release of counterions. Studies have shown that in films prepared by the adsorptive layer-by-layer technique, substantial interdigitation of the polyanion and polycation layers occurs and results in films with relatively little compositional variation across its thickness [see Losche, et al., 31 Macromolecules 8893 (1998)]. Although there is extensive intermingling of neighboring layers over a range of 4-6 nominal layers, it is possible to obtain actual layers of different composition, or strata, by interspersing several layers made from one pair of polyelectrolytes by several layers made from a different pair.

The total thickness of the polyelectrolyte film depends on many factors, including the types of polymers, molecular weight of the polymers, number of layers deposited, ionic strength of the solutions, pH of the solutions, deposition time, deposition temperature, and solvent used. The thickness of each deposited layer within the polyelectrolyte film typically changes as more layers are added to the film. Initial layer thicknesses are often on the order of a few nanometers [see Michel, et al., Ouyang, et al., 310 Journal of Membrane Science 76-84 (2008)] and may correspond to the sum of the characteristic size of the polyanion and polycation. Linear film growth is often followed by an exponential growth phase in which a roughening of successively deposited layers or migration of previously deposited mobile polyelectrolyte to the film surface leads to a progressively larger number of adsorption sites for consecutive generations of adsorbed polymer and, thus, to an increase in layer thicknesses with an increasing number of deposited layers. Because of the interpenetration of adjacent polyelectrolyte species and the finite adsorption times, however, this increase settles quickly into an equilibrium thickness. Greater polyelectrolyte layer deposition thicknesses can also be realized by increasing the ionic strength of the deposition solution, which screens the intramolecular electrostatic interactions within the polyelectrolyte chain and yields a more-coiled chain structure with greater void fraction.

Polyelectrolyte membrane solvent permeability and solute rejection are highly dependent upon the type of polyelectrolytes employed, the deposition conditions, and the number of polyelectrolyte layers applied. While some polyelectrolyte membranes have been prepared with only a few polyelectrolyte layers, some high-rejection polyelectrolyte membranes require the deposition of over fifty polyelectrolyte bilayers. To further improve solute rejection and membrane stability, polyelectrolyte membranes can be crosslinked, most often through amide or siloxane bond formation.

Although the layer-by-layer approach to membrane fabrication provides great flexibility for membrane synthesis using low-cost, water-soluble precursors and a variety of flat-sheet or tubular polymeric substrates, there are nonetheless several drawbacks to the approach, as well. This approach requires a substrate that has an affinity for one of the polyelectrolytes to initiate the coating process; deposition of several to up to over fifty polyelectrolyte layers is time- and coating-equipment-intensive; post-deposition chemical crosslinking can be time-consuming; the need to rinse off unbound polyelectrolyte creates waste; and the membrane structure can be disrupted at high ionic strengths and extreme pHs. Furthermore, many polyelectrolyte membranes rely upon Donnan exclusion to reject charged solutes, wherein anions are repelled by negatively charged membrane elements, and wherein cations are repelled by positively charged membrane elements. Although high divalent-ion rejections can be realized with polyelectrolyte membranes tested with single salt solutions, rejections when operating with mixed salt solutions, containing both divalent cations and divalent anions, are substantially lower, as coordination of divalent ions of opposite charge (counter-ions) to the membrane can reduce the magnitude of the membrane charge and permit increased passage of ions of the same charge as the membrane (co-ions). It is particularly difficult to realize polyelectrolyte membranes that simultaneously exhibit greater than 85% Na₂SO₄, MgCl₂, CaCl₂), and MgSO₄ rejections at water permeabilities in excess of 5 L/m²/h/bar.

Membranes based upon graphene and other two-dimensional (2-D) materials (i.e., materials with sheet- or plate-like morphologies that are from one to several atoms thick) have also been developed for RO, NF and FO applications. Graphene oxide, in particular, has been shown to be an effective membrane for certain aqueous separations. Permselectivity has generally been accomplished by generating atomic-scale pores in the 2-D sheet or making use of the interlamellar spacing between stacked sheets as a conduit for transport. In the latter case, permselectivity can be achieved through functionalization of the 2-D sheet surfaces and control of the interlamellar spacing. Graphene oxide has been shown to possess a unique ability to selectively transport water relative to less hydrophilic and larger atoms, ions, and molecules at extremely high rates. The high water permeability and permselectivity of graphene oxide has been attributed to the ability of portions of its oxidized surface, containing epoxy, hydroxyl, carbonyl, and carboxyl functionalities, to hydrogen bond with water molecules and promote an interlamellar spacing large enough for individual sheets of water molecules to pass through along the graphitic regions in a near frictionless manner, while preventing the passage of larger ions and molecules. Neutron scattering and x-ray diffraction measurements have shown that while dry graphene oxide prepared via the Hummer's method exhibits a interlamellar spacing of ˜6 Å, it can swell to as high as ˜11 Å in the presence of water, providing space for one or two monolayers of water within the interlamellar region.

Deposition of 2-D materials into a supported membrane can be conducted via a variety of coating techniques, including pressurized filtration, vacuum filtration, spray coating, knife casting, spin coating, gravure coating, and reverse roll coating.

Although membranes comprising layered 2-D materials have been shown to exhibit very high water permeabilities, they suffer from poor solute rejection and structural instability. Layered graphene oxide membranes exhibit excellent rejection for moderate molecular weight (greater than 500 Da) organic dyes but poor rejection of aqueous ions of common concern in water treatment applications. While the negative surface charge of graphene oxide does provide for some charge-based rejection of divalent anions, such as SO₄²⁻ and PO₄³⁻, rejection of cations responsible for hardness, such as Mg²⁺ and Ca²⁺, is very low. The layered structure of 2-D material-based membranes is also prone to delamination due to interlamellar swelling and hydrodynamic shear. Chemical or electrostatic crosslinking of 2-D membranes or physical encapsulation can improve membrane stability under test conditions but typically reduces membrane permeability, as it constrains interlamellar swelling and blocks solvent diffusion pathways.

Although membrane-based purification of water offers the potential for water purification with reduced complexity and energy input relative to conventional distillation, filtration and chemical treatment processes, existing membranes, in general, do not offer the performance and durability required for cost-effective widespread application. Membranes that offer higher solvent permeability, higher solute retention, improved fouling resistance, and improved oxidant resistance at lower cost are desired.

### SUMMARY

Described herein are high-permeability water purification membranes and processes for the production thereof.

A membrane for purifying a liquid stream includes a porous substrate and alternating layers of positively charged material and negatively charged material adhered to the porous substrate, wherein at least two of the layers of charged materials possess free ion exchange capacity.

Embodiments of the membrane can be formed by depositing a polymeric solution including a polymer and a first solvent in which the polymer is soluble on a non-woven fibrous support to produce a film having a thickness from about 50 to 300 microns on the non-woven fibrous support. The non-woven fibrous support and film of polymeric solution is then immersed in a non-solvent bath in which the polymer is insoluble, wherein the non-solvent bath induces a non-solvent phase separation of the polymeric solution to yield a porous substrate comprising the non-woven fibrous support coated with the polymer. At least three alternating layers of polycationic and polyanionic solutions with layer thicknesses of 4 to 35 microns are then deposited on the porous substrate to form charged material layers.

In particular embodiments, the membranes are directed to nanofiltration applications, as they reject both ionic and non-ionic solutes, while also resisting fouling and degradation from exposure to oxidants used for biological control and disinfection. In particular embodiments, the membranes comprise multiple layers of polyelectrolytes of defined thicknesses supported on a porous polymeric substrate. The use of different amounts of polyanionic and polycationic species results in extrinsic charge compensation within the membrane and yields a multipolar layered structure that may contribute to charged-based solute rejection. In another embodiment, the membranes comprise multiple layers of polyelectrolytes and two-dimensional materials of defined thicknesses supported on a porous substrate. The two-dimensional materials serve to enhance steric solute rejection, contribute to charge-based solute rejection, reduce membrane roughness, reduce polyelectrolyte penetration into the polymer support, and reduce fouling propensity.

The membranes of this disclosure can be employed to reduce the cost and improve the performance of water-purification systems. These and other advantages and attainments of embodiments of the present invention will become apparent to those skilled in the art upon a reading of the following detailed description and illustrative embodiment of the invention.

### BRIEF DESCRIPTION OF THE DRAWINGS

In the course of the following detailed description, reference will be made to the attached drawings in which:

FIG. 1 is a side sectional view of one embodiment of the membrane structure.

FIG. 2 is a side sectional view of an alternative embodiment of the membrane structure.

FIG. 3 is a side view illustrating a method of producing the membrane.

FIG. 4 is a magnified photographic image of an embodiment of the membrane microstructure.

The drawings are not necessarily to scale; instead, an emphasis is placed upon illustrating particular principles in the exemplifications discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Embodiments of the membrane of this disclosure comprise a multilayered structure composed of well-defined layers of negatively charged polymers, positively charged polymers, and 2-D materials supported on a porous polymeric substrate. The mass of polyelectrolytes and 2-D materials in each layer of the membrane can be precisely controlled through application of polyelectrolyte and 2-D material solutions of known film thickness. The ability to deposit polyelectrolyte and 2-D materials in excess of the amount that would normally be adsorbed via charge-based complexation enables excess charge to be retained within select layers of the membrane. Without wishing to be bound by any particular theory, it appears that the presence of layers containing excess positive and negative charges within the membrane causes reversal of the electric field within the membrane and yields a bipolar or multipolar structure capable of rejecting both multivalent anions and cations.

The term, “polyelectrolyte,” is used herein to designate a polymer with repeat units bearing functional groups that dissociate in water.

The term, “polyanion,” is used herein to designate a polymer with repeat units bearing a negatively charged functional group when dissolved in water.

The term, “polycation,” is used herein to designate a polymer with repeat units bearing a positively charged functional group when dissolved in water.

The term, “2-D material,” is used herein to designate organic or inorganic materials that exist in microscale sheet- or plate-like morphologies, wherein the sheets or plates are from one-to-several atoms thick.

The term, “flux,” is used herein to designate the volumetric rate of flow of the permeate across a membrane, usually in dimensions of liters per square meter per hour (LMH).

The term, “permeability,” is used herein to designate the volumetric rate of flow of the permeate across a membrane under a pressure gradient, usually in dimensions of liters per square meter per hour per bar (LMHB), wherein the pressure gradient is the imposed pressure gradient minus the difference in osmotic pressure between the feed and the permeate.

The term, “rejection,” is used herein to designate the percentage of a solute that does not permeate the membrane.

The term, “selective,” is used herein to designate that the described part has a tendency to allow one or more specific components of the feedstream to preferentially pass through that part with respect to the other feedstream components.

The term, “hardness,” is used herein to designate the amount of dissolved species, predominantly Mg′ and Ca′ ions, that are prone to precipitating from solution and depositing as a scale on water system hardware.

The term, “nominal charge density,” is used herein to designate the amount of positively or negatively ionized or readily ionizable groups present within an isolated film, usually in dimensions of milliequivalents per square meter (meq/m²).

The term, “gravimetric charge density,” is used herein to designate the amount of positively or negatively ionized or readily ionizable groups present within an isolated film, usually in dimensions of milliequivalents per gram (meq/g).

The term, “free ion exchange capacity,” is used herein to designate the amount of positively or negatively ionized or readily ionizable groups in a layer available to interact with aqueous ions (thereby excluding positively or negatively ionized groups electrostatically bound to oppositely charged groups associated with adjacent layers), usually in dimensions of milliequivalents per square meter (meq/m²).

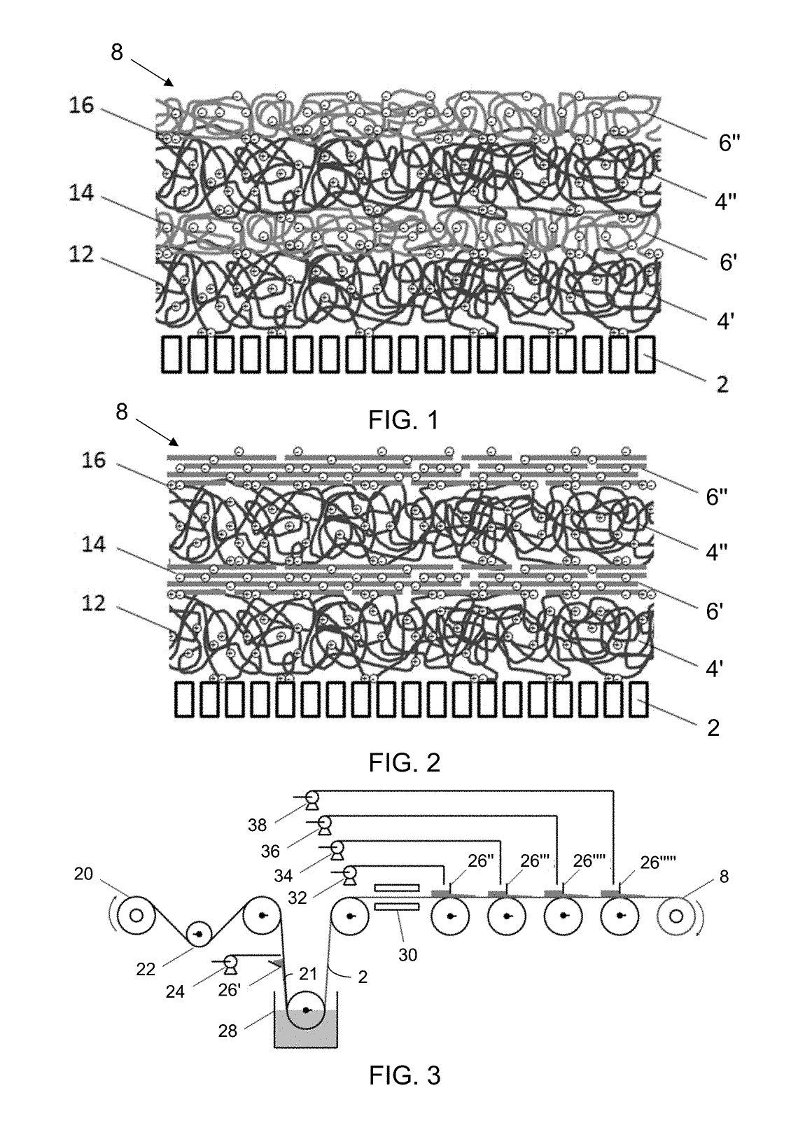

Now, referring to FIGS. 1-4, features and details of the layered membranes and methods of production are described. Particular embodiments are detailed, below, for the purpose of illustration and not as limitations of the invention.

FIG. 1 is a representation of a membrane 8 comprising two bilayers of positively charged and negatively charged polyelectrolytes supported on a porous polymer substrate. The porous polymer substrate 2 supports a first positively charged material 4′ in the form of a polycationic layer that electrostatically interacts with the negatively charged substrate 2 surface and provides a uniform, well-adhered polycationic coating. The first positively charged material (polycationic layer) 4′ supports a first negatively charged material 6′ in the form of a polyanionic layer that interacts with the surface of the first positively charged material (polycationic layer) 4′ through an electrostatic interaction 16. Although the positive electric charge 12 of the first positively charged material (polycationic layer) 4′ is partially neutralized at the interfaces with the substrate 2 and the first negatively charged material 6′ (polyanionic layer), the first positively charged material (polycationic layer) 4′ is thick enough that it retains uncompensated positive electric charge (free anion exchange capacity) 12 at its interior. The first negatively charged material 6′ (polyanionic layer) supports a second positively charged material 4″ (polycationic layer) that interacts with the surface of the first negatively charged material 6′ (polyanionic layer) through an electrostatic interaction 16. Although the negative electric charge 14 of the first negatively charged material 6′ (polyanionic layer) is partially neutralized at the interfaces with the first positively charged material (polycationic layer) 4′ and the second positively charged material 4″ (polycationic layer), the first negatively charged material 6′ (polyanionic layer) is thick enough that it retains uncompensated negative electric charge (free cation exchange capacity) 14 at its interior. The second positively charged material 4″ (polycationic layer) supports a second negatively charged material 6″ (polyanionic layer) that interacts with the surface of the second positively charged material 4″ (polycationic layer) through an electrostatic interaction 16. Although the positive electric charge 12 of the second positively charged material 4″ (polycationic layer) is partially neutralized at the interfaces with the first negatively charged material 6′ (polyanionic layer) and the second negatively charged material 6″ (polyanionic layer), the second positively charged material 4″ (polycationic layer) is thick enough that it retains uncompensated positive electric charge (free anion exchange capacity) 12 at its interior. The second negatively charged material 6″ (polyanionic layer) retains uncompensated negative electric charge (free cation exchange capacity) 14 that defines the overall surface charge of the membrane 8.

Adhesion of a first polyelectrolyte layer via application of a first polyelectrolyte solution 32 to the surface of the substrate 2, as shown in FIG. 3, can be accomplished through a variety of polyelectrolyte-substrate interactions, including electrostatic attraction, hydrophobic interactions, hydrogen bonding, chemical crosslinking, thermal crosslinking, or physical entanglement.

The number of polyelectrolyte layers applied to the substrate 2 is typically about 2 to 10 layers, and may be about 2 to 6 layers or, more specifically, about 3 to 5 layers. It is advantageous to use as few polyelectrolyte layers as possible, while still retaining desired rejection properties, in order to minimize the resistance of the membrane to solvent permeation and to minimize the time and steps required to prepare the membrane 8.

The polyelectrolyte layers can be deposited in any sequence, but are preferably deposited in an alternating sequence, wherein a polycationic layer is followed by a polyanionic layer, which is followed by a polycationic layer and so on. The first polyelectrolyte layer supported on the porous polymer substrate 2 may be a polycationic or a polyanionic material. The final polyelectrolyte layer that comprises the surface of the membrane 8 may be a polycationic or a polyanionic material.

The loading of each polyelectrolyte (polycationic or polyanionic) layer 4/6 is typically about 2 to 32 mg/m²—e.g., about 4 to 16 mg/m², and, in more-particular embodiments, about 4 to 8 mg/m². At an approximate density of 1 g/cm³, the thickness of each polyelectrolyte layer 4/6 is typically about 2 to 32 nm—e.g., about 4 to 16 nm, and, in more-particular embodiments, about 4 to 8 nm. At an approximate gravimetric charge density of 6 meq/g, the nominal charge density of each polyelectrolyte layer 4/6 is typically about 0.012 to 0.192 meq/m²—e.g., about 0.024 to 0.96 meq/m², and, in more—particular embodiments, about 0.024 to 0.048 meq/m². At very-low polyelectrolyte layer loadings, there may be no uncompensated electric charge (free ion exchange capacity) within the polyelectrolyte layer 4/6. At very-low polyelectrolyte layer loadings, it may also be possible to deposit more than one sequential layer of the same polyelectrolyte 4/6 and get sufficient layer adhesion through the underlying polyelectrolyte layer 4/6 to the oppositely charged polyelectrolyte layer 4/6 below.

The relative amounts of nominal polycation charge density (in meq/m²) and nominal polyanion charge density impact the ability of the membrane 8 to reject divalent salts. Membranes 8 with an excess of nominal polycation charge density relative to nominal polyanion charge density exhibit high rejections for salts containing divalent cations. Membranes 8 with an excess of nominal polyanion charge density relative to nominal polycation charge density exhibit high rejections for salts containing divalent anions. At specific ratios of total nominal polycation charge density to nominal polyanion charge density, high rejections for salts containing both divalent cations and divalent anions are realized. The ratio of total nominal polycation charge density to nominal polyanion charge density is typically about 0.1 to 10—e.g., about 1 to 7 or 1.5 to 5, and, in more-particular embodiments, 2 to 4. At specific ratios of nominal polycation charge density to nominal polyanion charge density for the ultimate polyelectrolyte layers, high rejections for salts containing both divalent cations and divalent anions are realized. The ratio of nominal polycation charge density to nominal polyanion charge density in the ultimate layers 4 and 6 (i.e., the outermost two layers from the porous substrate 2) of the membrane 8 is typically about 0.1 to 10—e.g., about 1 to 7, and in more-particular embodiments, 1.5 to 5 or 2 to 4.

Due to the association of polycation charges and polyanion charges in the interfaces between the layers, the amount of free ion exchange capacity (i.e., point charges that are not already electrostatically bound to other polymeric species) in each layer 4/6 is less than the nominal charge density. The free-ion-exchange capacity is typically greater than 20% of the nominal charge density—e.g., greater than 40% of the nominal charge density, and in more-particular embodiments, greater than 60% of the nominal charge density or even greater than 80% of the nominal charge density. The free ion exchange capacity of each polyelectrolyte layer 4/6 is typically greater than 0.002 meq/m²—e.g., greater than 0.02 meq/m², greater than 0.1 meq/m² or even greater than 0.5 meq/m².

The polyelectrolytes used to form the charged layers 4 and 6 are water- and/or organic-soluble and comprise a monomer unit that is positively or negatively charged in solution. The polyelectrolytes may be copolymers that have a combination of charged and/or neutral monomers (e.g., positive and negative; positive and neutral; negative and neutral; or positive, negative and neutral). Regardless of the exact combination of charged and neutral monomers, a polyelectrolyte used in the present invention is predominantly positively charged or predominantly negatively charged and, hereinafter, is referred to as a polycation or a polyanion, respectively.

Examples of polycations include polyelectrolytes comprising a quaternary ammonium group, such as poly(diallyldimethylammonium chloride) (PDADMAC), poly(vinylbenzyltrimethylammonium chloride) (PVBTMAC), poly(acryloxyethyltrimethyl ammonium chloride), poly(methacryloxy(2-hydroxy)propyltrimethyl ammonium chloride), ionenes, their salts, and copolymers thereof; polyelectrolytes comprising a pyridinium group, such as poly(N-methylvinylpyridinium) (PMVP); and protonated polyamines, such as poly(allylamine hydrochloride) (PAH) and polyethyleneimine (PEI). Polycation gravimetric charge densities are typically about greater than 4 meq/g—e.g., greater than 6 meq/g or even greater than 8 meq/g.

Examples of polyanions include polyelectrolytes comprising a sulfonate group (R—SO₃⁻), such as poly(styrenesulfonic acid) (PSS), poly(2-acrylamido-2-methyl-1-propane sulfonic acid), poly(vinylsulfonic acid) (PVS), sulfonated poly(ether ether ketone) (SPEEK), poly(ethylenesulfonic acid), poly(methacryloxyethylsulfonic acid), their salts, and copolymers thereof; and polycarboxylates, such as poly(acrylic acid) (PAA) and poly(methacrylic acid). Polyanion gravimetric charge densities are typically about greater than 3 meq/g—e.g., greater than 5 meq/g or even greater than 7 meq/g.

The molecular weight of the polyelectrolytes is typically about 10,000 to 2,000,000 g/mol—e.g., about 20,000 to 1,000,000 g/mol, and, in more-particular embodiments, about 50,000 to 500,000 g/mol. When employing thicker polyelectrolyte layers 4/6, higher-molecular-weight polyelectrolytes are more likely to yield stable layers 4/6, as single-polymer chains may span the polyelectrolyte layer 4/6 and may be electrostatically bound to the underlying and overlaying polyelectrolyte layers 4/6. Higher-molecular-weight polyelectrolytes 4/6 are also less likely to penetrate into the pores of the polymer substrate 2.

The substrate 2 used to support the polyelectrolyte films 4/6 is typically a porous polymer having surface pores with an average diameter of less than about 500 nm—e.g., less than about 200 nm, less than about 50 nm, less than about 20 nm or even less than about 10 nm. The pores of the substrate may be asymmetric or symmetric. The substrate 2 can comprise a polymer, such as polyacrylonitrile (PAN), polysulfone (PS), polyethersulfone (PES), polyester (PET), polyvinylidene difluoride (PVDF), polyimide (PI), polyether ether ketone (PEEK), or mixtures thereof. The substrate 2 can also comprise a non-woven support mesh formed of polyester or polyolefin to improve the substrate's mechanical strength. The thickness of the substrate 2 is typically about 20 to 200 microns—e.g., about 40 to 160 microns, and, in more-particular embodiments, about 70 to 130 microns.

Two-dimensional (2-D) materials (e.g., single- or few-atomic-layer materials) may be substituted for one or more of the polyelectrolyte layers as the charged material 4/6 to produce a membrane 8 with improved permeation and rejection characteristics. FIG. 2 is a representation of a membrane 8 comprising two bilayers of positively charged and negatively charged 2-D materials 4 and 6 supported on a porous polymer substrate 2. The porous polymer substrate 2 supports a first positively charged material 4′ (polycationic layer) that electrostatically interacts with the negatively charged substrate 2 surface and provides a uniform, well-adhered polycationic coating. The first positively charged material 4′ (polycationic layer) supports a first polyanionic layer 6′ (here, in the form a 2-D material layer) that interacts with the surface of the first positively charged material 4′ (polycationic layer) through an electrostatic interaction 16. Although the positive electric charge 12 of the first positively charged material 4′ (polycationic layer) is partially neutralized at the interfaces with the substrate 2 and the first polyanionic layer 6′ (2-D material layer), the first positively charged material 4′ (polycationic layer) is thick enough that it retains uncompensated positive electric charge (free anion exchange capacity) 12 at its interior. The first polyanionic layer 6′ (2-D material layer) supports a second positively charged material 4″ (polycationic layer) that interacts with the surface of the first polyanionic layer 6′ (2-D material layer) through an electrostatic interaction 16. Although the negative electric charge 14 of the first polyanionic layer 6′ (2-D material layer) is partially neutralized at the interfaces with the first positively charged material 4′ (polycationic layer) and the second positively charged material 4″ (polycationic layer), the first polyanionic layer 6′ (2-D material layer) is thick enough that it retains uncompensated negative electric charge (free cation exchange capacity) 14 at its interior. The second positively charged material 4″ (polycationic layer) supports a second polyanionic layer 6″ (2-D material layer) that interacts with the surface of the second positively charged material 4″ (polycationic layer) through an electrostatic interaction 16. Although the positive electric charge 12 of the second positively charged material 4″ (polycationic layer) is partially neutralized at the interfaces with the first polyanionic layer 6′ (2-D material layer) and the second polyanionic layer 6″ (2-D material layer), the second positively charged material 4″ (polycationic layer) is thick enough that it retains uncompensated positive electric charge (free anion exchange capacity) 12 at its interior. The second polyanionic layer 6″ (2-D material layer) retains uncompensated negative electric charge (free cation exchange capacity) 14 that defines the overall surface charge of the membrane 8.

Positively charged 2-D materials may be substituted for one or more of the polycationic layers as the positively charged material 4, while negatively charged 2-D materials may be substituted for one or more of the polyanionic layers as the negatively charged material. The 2-D material serves to improve steric-based solute rejection, as solutes have to pass through the interlamellar gap of the 2-D materials in order to permeate through the membrane 8. The presence of uncompensated charge (free ion exchange capacity) in the 2-D material layer preserves the multipolar characteristics of the membrane 8 and the charged-based rejection characteristics of the membrane 8.

Examples of negatively charged 2-D materials include graphene oxide, boron nitride and transition metal chalcogenides, such as molybdenum sulfide and tungsten sulfide. Sulfonic acid-, sulfonate-, carboxyl-, and carboxylate-functionalized versions of the same 2-D materials can also be employed.

Examples of positively charged 2-D materials include quaternary ammonium-, pyridinium-, and amine-functionalized versions of the same 2-D materials.

In addition to modifying solute rejection, the incorporation of 2-D materials into the layered membrane 8 can enhance solvent permeability and membrane durability. When used as the layer directly supported by the porous substrate, the 2-D material can span the pores of the substrate and minimize penetration of subsequent polyelectrolyte layers into the substrate pores, thereby reducing the resistance of the membrane to solvent permeation.

The 2-D material, whether used as the first, intermediate, and/or final layer of the membrane coating, can also reduce the roughness of the membrane surface by spanning and covering the textural irregularities of the substrate 2 and/or polyelectrolyte layers 4/6. By rendering the surface of the membrane smoother, the fouling propensity of the membrane 8 can be reduced.

The 2-D material, when used as the final layer of the membrane coating, can also reduce fouling due to biological film growth through antimicrobial action. Graphene oxide and several transition metal chalcogenides have been shown to exhibit antimicrobial properties.

An exemplary process used to prepare the layered membrane employs common coating techniques that enable rapid, low-cost membrane production. FIG. 3 is a representation of a roll-to-roll process that can be employed to produce the layered membrane 8. A non-woven fibrous support 20 is conveyed across a series of rollers 22 and through a series of coating steps to yield the layered membrane 8. A polymer solution 24 (e.g., a solution comprising polyacrylonitrile (PAN), polysulfone (PS), polyethersulfone (PES), polyester (PET), polyvinylidene difluoride (PVDF), polyimide (PI), polyether ether ketone (PEEK), or mixtures thereof) is deposited on the non-woven support 20; and a metering instrument 26′, such as a doctor blade or Mayer rod, is used to spread the first polymer solution 24 to a prescribed film thickness upon the surface of the non-woven support 20. The wetted non-woven support 21 is conveyed through a non-solvent bath 28 to induce a non-solvent phase separation of the polymer solution film and to yield a porous substrate 2 suitable for subsequent thin film coating.

After submersion in the non-solvent bath 28 for a prescribed length of time, the membrane substrate is conveyed through a heater 30 to remove residual solvent and non-solvent from the membrane substrate 2. A first polyelectrolyte solution 32 is then applied to the membrane substrate 2 and metered to a prescribed film thickness with metering instrument 26″. Following solvent evaporation and solvent absorption by the substrate 2, a second polyelectrolyte solution 34 is then applied to the membrane substrate 2 and metered to a prescribed film thickness with metering instrument 26′″. Following solvent evaporation and solvent absorption by the substrate 2, a third polyelectrolyte solution 36 is then applied to the membrane substrate 2 and metered to a prescribed film thickness with metering instrument 26″. Following solvent evaporation and solvent absorption by the substrate 2, a fourth polyelectrolyte solution 38 is then applied to the membrane substrate 2 and metered to a prescribed film thickness with metering instrument 26″″. Following solvent evaporation and solvent absorption by the substrate 2, the layered membrane 8 is produced.

Any method capable of yielding a prescribed thickness of solution 24/32/34/36/38 on the surface of the non-woven support 20 or membrane substrate 2 can be used to apply the polymer solution 24 or polyelectrolyte solutions 32, 34, 36, and 38. These methods include spray coating, gravure coating, reverse roll coating, knife coating, slot coating, and Mayer rod coating. The film thickness of the polymer solution 24 is typically about 50 to 300 microns—e.g., about 70-200 microns, and, in more-particular embodiments, about 80 to 150 microns. The film thickness of the polyelectrolyte solution 32/34/36/38 is typically about 4 to 35 microns—e.g., about 6 to 25 microns, and, in more-particular embodiments, about 6 to 15 microns.

The process used to prepare the layered membrane 8 lends itself to high-speed production. The membrane 8 is typically conveyed through the coating process at a speed of about 1 to 200 m/min—e.g., at a speed of about 10 to 150 m/min, and, in more-particular embodiments, at a speed of about 20 to 100 m/min or at a speed of 30 to 70 m/min.

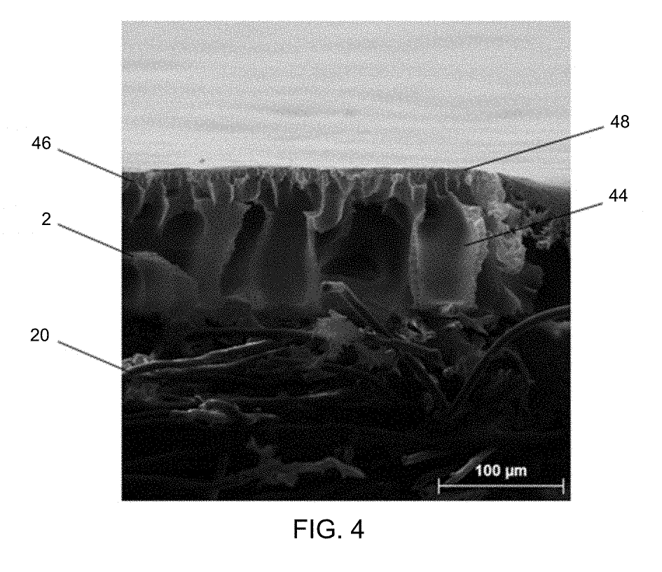

FIG. 4 represents an image of a layered membrane in cross-section. Visible in the image are the non-woven support 20, the porous polymer substrate 2, macropores 44 in the polymer substrate 2, micropores 46 in the polymer substrate 2, and the polymer substrate skin and layered film 48.

In addition to non-solvent induced phase separation, the porous polymer substrate can also be produced via thermally induced phase separation.

The layered membrane is typically integrated into spiral-wound membrane elements for use in conventional membrane housings. The spiral-wound membrane comprises spiral wraps of layered membrane sheets interspersed with a permeate spacer and feed spacer wrapped around a central tube that acts as a conduit for permeate passage. The solution to be purified enters the spiral-wound membrane element through passages formed by the feed spacer, passes through the layered membrane, flows through the permeate spacer, and into the permeate tube. The layered membrane may also be integrated into flat-sheet membrane cells.

The following examples illustrate formulations of the inventive membrane and methods of synthesizing and using the membrane.

### EXEMPLIFICATIONS

### Example 1

A porous polymer substrate was prepared by casting polyacrylonitrile on a non-woven polyester support. A solution containing 14 wt % poly(acrylonitrile-co-methyl acrylate) (Scientific Polymer Products, Inc.) in dimethylformamide was deposited on a non-woven polyester support with a basis weight of 80 g/m² and metered to a thickness of 270 microns with a doctor blade. The non-woven support and wet film was immediately submerged in a 50° C. water bath for three minutes, followed by a 20° C. water bath for 8 minutes. Following air drying for one hour, the pure-water permeability of the porous substrate was measured to be 1424 L/m²/h/bar.

### Example 2

A porous polymer substrate was prepared by casting a polyacrylonitrile blend on a non-woven polyester support. A solution containing 9-wt % poly(acrylonitrile) (Sigma-Aldrich) and 1-wt % poly(acrylonitrile-co-2-acrylamido-2-methylpropanesulfonic acid) (Scientific Polymer Products, Inc.) in dimethylformamide was deposited on a non-woven polyester support with a basis weight of 80 g/m² and metered to a thickness of 270 microns with a doctor blade. The support and wet film was immediately submerged in a 20° C. water bath for three minutes, followed by a second 20° C. water bath for 8 minutes. Following air drying for one hour, the pure water permeability of the porous substrate was measured to be 1530 L/m²/h/bar.

### Example 3

A porous polymer substrate was hydrolyzed by soaking a poly(acrylonitrile) substrate (PA350, Nanostone Water, Inc.) in 1 mol/L NaOH for 30 minutes. The substrate was rinsed with water and dried at 20° C.

### Example 4

A porous polymer substrate was hydrolyzed by soaking the substrate of Example 1 in 1 mol/L NaOH for 30 minutes. The substrate was rinsed with water and dried at 20° C.

### Example 5

A 6-micron-thick film of 0.5-wt % PAH (900 kDa, Sigma-Aldrich) in water was deposited on the substrate of Example 3 using a 2.5-mil Mayer rod at a coating speed of 10 m/min. Following drying at 20° C. for 5 minutes, a 6-micron-thick film of 0.5-wt % PSS (70 kDa, Sigma-Aldrich) in water was deposited on the membrane using the same coating conditions.

Following drying at 20° C. for 5 minutes, a 6-micron-thick film of 0.5-wt % PAH (900 kDa, Sigma-Aldrich) in water was deposited on the membrane using the same coating conditions. Following drying at 20° C. for 5 minutes, a 6-micron-thick film of 0.5-wt % PSS (70 kDa, Sigma-Aldrich) in water was deposited on the membrane using the same coating conditions. The membrane comprised polyelectrolyte layers with nominal loadings of 32, 32, 32, and 32 mg/m² and nominal charge densities of 0.34, 0.16, 0.34, and 0.16 meq/m².

### Example 6

A 6-micron-thick film of 0.18-wt % PAH (900 kDa, Sigma-Aldrich) in water was deposited on the substrate of Example 3 using a 2.5-mil Mayer rod at a coating speed of 10 m/min. Following drying at 20° C. for 5 minutes, a 6-micron-thick film of 0.25-wt % PSS (70 kDa, Sigma-Aldrich) in water was deposited on the membrane using the same coating conditions. Following drying at 20° C. for 5 minutes, a 6-micron-thick film of 0.18-wt % PAH (900 kDa, Sigma-Aldrich) in water was deposited on the membrane using the same coating conditions. Following drying at 20° C. for 5 minutes, a 6-micron-thick film of 0.25-wt % PSS (70 kDa, Sigma-Aldrich) in water was deposited on the membrane using the same coating conditions. The membrane comprised polyelectrolyte layers with nominal loadings of 12, 16, 12, and 16 mg/m² and nominal charge densities of 0.13, 0.078, 0.13, and 0.078 meq/m².

### Example 7

A 6-micron-thick film of 0.25-wt % PDADMAC (400 kDa, Sigma-Aldrich) in water was deposited on the substrate of Example 3 using a 2.5-mil Mayer rod at a coating speed of 10 m/min. Following drying at 20° C. for 5 minutes, a 6-micron-thick film of 0.125-wt % PSS (70 kDa, Sigma-Aldrich) in water was deposited on the membrane using the same coating conditions. Following drying at 20° C. for 5 minutes, a 6-micron-thick film of 0.25-wt % PDADMAC (400 kDa, Sigma-Aldrich) in water was deposited on the membrane using the same coating conditions. Following drying at 20° C. for 5 minutes, a 6-micron-thick film of 0.125-wt % PSS (70 kDa, Sigma-Aldrich) in water was deposited on the membrane using the same coating conditions. The membrane comprised polyelectrolyte layers with nominal loadings of 16, 8, 16, and 8 mg/m² and nominal charge densities of 0.099, 0.039, 0.099, and 0.039 meq/m².

### Example 8

A 6-micron-thick film of 0.25-wt % PDADMAC (400 kDa, Sigma-Aldrich) in water was deposited on the substrate of Example 3 using a 2.5-mil Mayer rod at a coating speed of 10 m/min. Following drying at 20° C. for 5 minutes, a 6-micron-thick film of 0.125-wt % PSS (70 kDa, Sigma-Aldrich) in water was deposited on the membrane using the same coating conditions. Following drying at 20° C. for 5 minutes, a 6-micron-thick film of 0.50-wt % PDADMAC (400 kDa, Sigma-Aldrich) in water was deposited on the membrane using the same coating conditions. Following drying at 20° C. for 5 minutes, a 6-micron-thick film of 0.094-wt % PSS (70 kDa, Sigma-Aldrich) in water was deposited on the membrane using the same coating conditions. The membrane comprised polyelectrolyte layers with nominal loadings of 16, 8, 32, and 6 mg/m² and nominal charge densities of 0.099, 0.039, 0.198, and 0.029 meq/m².

### Example 9

A 6-micron-thick film of 0.25-wt % PDADMAC (400 kDa, Sigma-Aldrich) in water was deposited on the substrate of Example 3 using a 2.5-mil Mayer rod at a coating speed of 10 m/min. Following drying at 20° C. for 5 minutes, a 6-micron-thick film of 0.125-wt % PSS (70 kDa, Sigma-Aldrich) in water was deposited on the membrane using the same coating conditions. Following drying at 20° C. for 5 minutes, a 6-micron-thick film of 0.125-wt % PDADMAC (400 kDa, Sigma-Aldrich) in water was deposited on the membrane using the same coating conditions. Following drying at 20° C. for 5 minutes, a 6-micron-thick film of 0.125-wt % PSS (70 kDa, Sigma-Aldrich) in water was deposited on the membrane using the same coating conditions. The membrane comprised polyelectrolyte layers with nominal loadings of 16, 8, 8, and 8 mg/m² and nominal charge densities of 0.099, 0.039, 0.050, and 0.039 meq/m².

### Example 10

A 6-micron-thick film of 0.125-wt % single-layer graphene oxide (ACS Materials) in water was deposited on the substrate of Example 3 using a 2.5-mil Mayer rod at a coating speed of 10 m/min. Following drying at 20° C. for 5 minutes, a 6-micron-thick film of 0.5-wt % PDADMAC (400 kDa, Sigma-Aldrich) in water was deposited on the membrane using the same coating conditions. Following drying at 20° C. for 5 minutes, a 6-micron-thick film of 0.125-wt % single-layer graphene oxide (ACS Materials) in water was deposited on the membrane using the same coating conditions. The membrane comprised polyelectrolyte and 2-D layers with nominal loadings of 8, 32, and 8 mg/m².

### Example 11

A 6-micron-thick film of 0.031-wt % PDADMAC (400 kDa, Sigma-Aldrich) in water was deposited on the substrate of Example 3 using a 2.5-mil Mayer rod at a coating speed of 10 m/min. Following drying at 20° C. for 5 minutes, a 23-micron-thick film of 0.1-wt % single-layer graphene oxide (ACS Materials) in water was deposited on the membrane using a 9-mil Mayer rod. Following drying at 20° C. for 5 minutes, a 6-micron-thick film of 0.25-wt % PDADMAC (400 kDa, Sigma-Aldrich) in water was deposited on the membrane using a 2.5-mil Mayer rod. Following drying at 20° C. for 5 minutes, a 6-micron-thick film of 0.093-wt % PSS (70 kDa, Sigma-Aldrich) in water was deposited on the membrane using the same coating conditions. The membrane comprised polyelectrolyte and 2-D layers with nominal loadings of 2, 23, 16, and 6 mg/m².

### Example 12

A 13-micron-thick film of 0.25-wt % PDADMAC (400 kDa, Sigma-Aldrich) in water was deposited on the substrate of Example 3 using a 5-mil Mayer rod at a coating speed of 10 m/min. Following drying at 20° C. for 5 minutes, a 13-micron-thick film of 0.063-wt % PSS (70 kDa, Sigma-Aldrich) in water was deposited on the membrane using the same coating conditions. Following drying at 20° C. for 5 minutes, a 13-micron-thick film of 0.125-wt % PDADMAC (400 kDa, Sigma-Aldrich) in water was deposited on the membrane using the same coating conditions. Following drying at 20° C. for 5 minutes, a 13-micron-thick film of 0.063-wt % PSS (70 kDa, Sigma-Aldrich) in water was deposited on the membrane using the same coating conditions. The membrane comprised polyelectrolyte layers with nominal loadings of 32, 8, 16, and 8 mg/m² and nominal charge densities of 0.198, 0.039, 0.099, and 0.039 meq/m².

### Example 13

A layer-by-layer polyelectrolyte membrane was prepared by coating a porous polymer substrate with alternating layers of PDADMAC and PSS. The substrate of Example 1 was immersed in 0.03 mol/L PDADMAC (400 kDa, Sigma-Aldrich) for 2 minutes, rinsed in water for 1 minute, immersed in 0.03 mol/L PSS (70 kDa, Sigma-Aldrich) for 2 minutes, and rinsed in water for 1 minute to deposit one polyelectrolyte bilayer. The coating process was repeated four additional times to produce a membrane comprising ten polyelectrolyte layers (5 bilayers). The membrane was dried at 20° C.

### Example 14

A layer-by-layer polyelectrolyte membrane was prepared by coating a porous polymer substrate with alternating layers of PDADMAC and PSS. The substrate of Example 4 was immersed in 0.03 mol/L PDADMAC (400 kDa, Sigma-Aldrich) for 2 minutes, rinsed in water for 1 minute, immersed in 0.03 mol/L PSS (70 kDa, Sigma-Aldrich) for 2 minutes, and rinsed in water for 1 minute to deposit one polyelectrolyte bilayer. The coating process was repeated one additional time to produce a membrane comprising four polyelectrolyte layers (2 bilayers). The membrane was dried at 20° C.

### Example 15

A layer-by-layer polyelectrolyte membrane was prepared by coating a porous polymer substrate with alternating layers of PDADMAC and PSS. The substrate of Example 4 was immersed in 0.03 mol/L PDADMAC (400 kDa, Sigma-Aldrich) for 2 minutes, rinsed in water for 1 minute, immersed in 0.03 mol/L PSS (70 kDa, Sigma-Aldrich) for 2 minutes, and rinsed in water for 1 minute to deposit one polyelectrolyte bilayer. The coating process was repeated four additional times to produce a membrane comprising ten polyelectrolyte layers (5 bilayers). The membrane was dried at 20° C.

### Example 16

A layer-by-layer polyelectrolyte membrane was prepared by coating a porous polymer substrate with alternating layers of PDADMAC and PSS. The substrate of Example 4 was immersed in 0.03 mol/L PDADMAC (400 kDa, Sigma-Aldrich) for 2 minutes, rinsed in water for 1 minute, immersed in 0.03 mol/L PSS (70 kDa, Sigma-Aldrich) for 2 minutes, and rinsed in water for 1 minute to deposit one polyelectrolyte bilayer. The coating process was repeated nine additional times to produce a membrane comprising 20 polyelectrolyte layers (10 bilayers). The membrane was dried at 20° C.

### Example 17

The permeation and rejection characteristics of a membrane were evaluated by challenging the membrane with a series of individual salt solutions containing 500 part per million by weight (ppm) of either MgCl₂, Na₂SO₄, MgSO₄ or NaCl. In a typical test, the membrane was loaded into a flat-sheet membrane holder leaving an exposed membrane area of 4.7 cm². Approximately 20 cc/min of the salt solution was passed over the membrane at a pressure of 3 bar. After stabilization, the permeate flow rate and concentration of salt in the permeate was measured. TABLE 1 summarizes the permeation data of several membranes.

TABLE 1
Membrane Permeability and Single Salt Rejection

| | Average | MgCl₂ | Na₂SO₄ | MgSO₄ | NaCl |
|---|---|---|---|---|---|
| | Water | Rejec- | Rejec- | Rejec- | Rejec- |
| | Permeability | tion | tion | tion | tion |
| Membrane | (L/m²/h/bar) | (%) | (%) | (%) | (%) |
| Example 5 | 6.1 | 98 | 73 | 90 | 62 |
| Example 6 | 7.8 | 37 | 86 | 58 | |
| Example 7 | 5.4 | 82 | 90 | 91 | |
| Example 8 | 6.6 | 87 | 94 | 94 | 19 |
| Example 9 | 7.1 | 17 | 90 | | |
| Example 10 | 5.5 | 96 | 42 | 75 | 63 |
| Example 11 | 7.6 | 36 | 73 | 46 | |
| Example 12 | 7.0 | 75 | 90 | 91 | 21 |
| Example 13 | 127 | 2 | 0 | | |
| Example 14 | 15.9 | 38 | 37 | | |
| Example 15 | 13.5 | 42 | 91 | | |
| Example 16 | 9.3 | 40 | 95 | 87 | 12 |

### Example 18

The membrane's permeation and rejection characteristics were evaluated by challenging the membrane with a mixed-salt solution containing 4.2 mmol/L each of Mg²⁺, Na⁺, SO₄²⁻, Cl⁻. In a typical test, the membrane was loaded into a flat sheet membrane holder leaving an exposed membrane area of 4.7 cm². Approximately 20 cc/min of the mixed-salt solution was passed over the membrane at a pressure of 3 bar. After stabilization, the flow rate, hardness, and total dissolved solids (TDS) content of the permeate was measured. TABLE 2 summarizes the permeation data of a layered membrane relative to commercial nanofiltration membranes.

TABLE 2
Membrane Permeability and Mixed Salt Rejection

| | Water | Hardness | TDS |
|---|---|---|---|
| | Permeability | Reduction | Reduction |
| Membrane | (L/m²/h/bar) | (%) | (%) |
| Example 12 | 7.6 | 89 | 64 |
| ESNA1-LF2 | 9.4 | 89 | 90 |
| NF-270 | 15.1 | 78 | 67 |

### Example 19

The permeation and rejection characteristics of the membrane of Example 12 was evaluated by challenging the membrane with a mixed-salt solution containing 4.2 mmol/L each of Mg²⁺, Na⁺, SO₄²⁻, Cl⁻. The membrane was loaded into a flat sheet membrane holder leaving an exposed membrane area of 4.7 cm². Approximately 20 cc/min of the mixed-salt solution was passed over the membrane at a pressure of 3 bar. After stabilization, the flow rate, hardness, and total dissolved solids (TDS) content of the permeate was measured. TABLE 3 summarizes the permeation data of the membrane over a period of 42 hours.

TABLE 3
Membrane Permeability and Mixed Salt Rejection

| Elapsed | Water | Hardness | TDS |
|---|---|---|---|
| Time | Permeability | Reduction | Reduction |
| (h) | (L/m²/h/bar) | (%) | (%) |
| 0 | 7.6 | 86 | 66 |
| 19 | 7.3 | 89 | 64 |
| 22 | 7.6 | 89 | 64 |
| 42 | 7.7 | 89 | 63 |

### Example 20

Membranes of Example 7 were soaked in an aqueous solution of 0.02 wt % NaOCl pH-adjusted to 8 with HCl for 0.5, 7.5 and 18.5 hours to examine Cl tolerance. The permeation and rejection characteristics of the membrane were then evaluated by challenging the membrane with a salt solution containing 500 part per million by weight (ppm) of MgSO₄. The membrane was loaded into a flat sheet membrane holder leaving an exposed membrane area of 4.7 cm². Approximately 20 cc/min of the mixed-salt solution was passed over the membrane at a pressure of 3 bar. After stabilization, the permeate flow rate and concentration of salt in the permeate was measured. TABLE 4 summarizes the changes in membrane permeation characteristics following different Cl exposures. A doubling in salt passage occurs after approximately 1900 ppmh Cl exposure.

TABLE 4
Changes in Membrane Permeability and MgSO₄ Passage

| Cl | Change in Water | Change in MgSO₄ |
|---|---|---|
| Exposure | Permeability | Passage |
| (ppmh) | (%) | (%) |
| 100 | 1 | −8 |
| 1500 | 8 | 85 |
| 3700 | 25 | 167 |

The use of the layered membrane in water-purification processes offers many advantages over the use of previously known membranes. The membrane can provide high rejection (greater than 90%) of divalent cations and anions while offering low rejection (less than 30%) for monovalent cations and anions. These properties are beneficial in low-pressure water-softening applications, where high hardness rejection and low salinity rejection are desired in order to minimize the osmotic pressure differential between the feed and the permeate and facilitate the use of a low feed pressure.

An advantage provided by embodiments of the membrane is that divalent salt rejections greater than 90% can be realized after deposition of as few as three polyelectrolyte/2-D layers. Most conventional adsorptive layer-by-layer prepared membranes require the deposition of greater than eight polyelectrolyte layers to achieve comparable divalent salt rejection.

An advantage provided by embodiments of the membrane is that Cl tolerance is improved relative to conventional thin film composite polyamide nanofiltration membranes.

An advantage provided by embodiments of the membrane is that very little solvent is required to deposit the polyelectrolyte/2-D layers. The thickness of each wet polyelectrolyte/2-D film is typically less than about 35 microns. Additionally, no rinsing of the membrane is required during polyelectrolyte/2-D layer deposition, which minimizes solvent and polyelectrolyte/2-D materials waste.

Because very little solvent is used in polyelectrolyte/2-D layer deposition, solvent evaporation or absorption into the porous support is rapid and subsequent layer deposition can occur within seconds, thus enabling substrate coating to take place at coating speeds as high as 200 m/min, enabling significant amounts of membrane to be produced on a single coating line. No elevated temperature is also required to complete curing or drying of the layered membrane.

An advantage provided by embodiments of the membrane is that thick and dense polyelectrolyte/2-D layers can be readily applied to the polymer substrate. In order to deposit thick polyelectrolyte layers via conventional adsorptive layer-by-layer methods, a supporting salt is needed to increase the ionic strength of the polyelectrolyte solution. While this salt increases the thickness of the coating, it also reduces the density of the coating.

An advantage provided by embodiments of the membrane is that the relative amounts of polyelectrolytes/2-D materials in adjacent layers can be manipulated in a straightforward manner by adjusting the polyelectrolyte/2-D solution concentration and film-coating thickness. The amount of polyelectrolyte deposited via conventional adsorptive layer-by-layer methods is impacted by a number of variables, including polyelectrolyte-solution concentration, solution temperature, solution ionic strength, solution pH, polyelectrolyte molecular weight, and substrate roughness.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/100^{th}, 1/50^{th}, 1/20^{th}, 1/10^{th}, 1/5^{th}, 1/3^{rd}, 1/2, 2/3^{rd}, 3/4^{th}, 4/5^{th}, 9/10^{th}, 19/20^{th}, 49/50^{th}, 99/100th, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of all references, including reference texts, journal articles, patents, patent applications, etc., cited throughout this application are hereby incorporated by reference in their entirety. All appropriate combinations of embodiments, features, characterizations, components and methods of those references and the present disclosure may be selected for inclusion in embodiments of the invention. Still further, the components and methods identified in the Background section are integral to this disclosure and can be used in conjunction with or substituted for components and methods described elsewhere in the disclosure within the scope of the invention.

What is claimed is:

1. A membrane for purifying a liquid stream, said membrane comprising:
a porous substrate; and
alternating layers of positively charged material and negatively charged material adhered to the porous substrate, wherein at least two of the layers of charged materials possess free ion exchange capacity.

2. The membrane of claim 1, wherein the porous substrate comprises:
a non-woven fibrous support; and
a polymer layer coating the non-woven fibrous support.

3. The membrane of claim 1, wherein the alternating layers comprise at least three alternating layers of charged materials.

4. The membrane of claim 3, wherein at least three of the alternating layers possess free ion exchange capacity.

5. The membrane of claim 1, wherein the alternating layers comprise at least four alternating layers of charged materials.

6. The membrane of claim 5, wherein at least four of the alternating layers possess free ion exchange capacity.

7. The membrane of claim 1, wherein the alternating layers comprise at least five alternating layers of charged materials.

8. The membrane of claim 7, wherein at least five of the alternating layers possess free ion exchange capacity.

9. The membrane of claim 1, wherein the alternating layers comprise at least six alternating layers of charged materials.

10. The membrane of claim 1, wherein each alternating layer comprises at least 2 mg/m² of charged material.

11. The membrane of claim 1, wherein each alternating layer comprises at least 4 mg/m² of charged material.

12. The membrane of claim 1, wherein each alternating layer comprises at least 8 mg/m² of charged material.

13. The membrane of claim 1, wherein each alternating layer comprises at least 16 mg/m² of charged material.

14. The membrane of claim 1, wherein each alternating layer comprises at least 32 mg/m² of charged material.

15. The membrane of claim 1, wherein the ratio of the total positively charged material nominal charge density to the total negatively charged material nominal charge density is between 0.1 and 10.

16. The membrane of claim 1, wherein the ratio of the total positively charged material nominal charge density to the total negatively charged material nominal charge density is between 1 and 7.

17. The membrane of claim 1, wherein the ratio of the total positively charged material nominal charge density to the total negatively charged material nominal charge density is between 1.5 and 5.

18. The membrane of claim 1, wherein the ratio of the total positively charged material nominal charge density to the total negatively charged material nominal charge density is between 2 and 4.

19. The membrane of claim 1, wherein the layers of positively charged material and negatively charged material include an ultimate positively charged material layer and an ultimate negatively charged material layer that are outermost from the porous substrate.

20. The membrane of claim 19, wherein the ratio of the nominal charge density of the ultimate positively charged material layer to the nominal charge density of the ultimate negatively charged material layer is between 0.1 and 10.

21. The membrane of claim 19, wherein the ratio of the nominal charge density of the ultimate positively charged material layer to the nominal charge density of the ultimate negatively charged material layer is between 1 and 7.

22. The membrane of claim 19, wherein the ratio of the nominal charge density of the ultimate positively charged material layer to the nominal charge density of the ultimate negatively charged material layer is between 1.5 and 5.

23. The membrane of claim 19, wherein the ratio of the nominal charge density of the ultimate positively charged material layer to the nominal charge density of the ultimate negatively charged material layer is between 2 and 4.

24. The membrane of claim 1, wherein the total free ion exchange capacity of the alternating layers is greater than 0.002 meq/m².

25. The membrane of claim 1, wherein the total free ion exchange capacity of the alternating layers is greater than 0.02 meq/m².

26. The membrane of claim 1, wherein the total free ion exchange capacity of the alternating layers is greater than 0.1 meq/m².

27. The membrane of claim 1, wherein the total free ion exchange capacity of the alternating layers is greater than 0.5 meq/m².

28. The membrane of claim 1, wherein the negatively charged material comprises a composition selected from poly(styrenesulfonic acid), poly(vinylsulfonic acid), poly(2-acrylamido-2-methyl-1-propanesulfonic acid), sulfonated poly(ether ether ketone), poly(ethylenesulfonic acid), poly(methacryloxyethylsulfonic acid), poly(acrylic acid), poly(methacrylic acid), graphene oxide, sulfonic acid-functionalized graphene oxide, carboxyl-functionalized graphene oxide, molybdenum sulfide, boron nitride, their salts and mixtures thereof.

29. The membrane of claim 1, wherein the positively charged material comprises a composition selected from poly(diallyldimethylammonium chloride), poly(vinylbenzyltrimethylammonium chloride), poly(acryloxyethyltrimethyl ammonium chloride), poly(methacryloxy(2-hydroxy)propyltrimethyl ammonium chloride), poly(N-methylvinylpyridinium), poly(allylamine hydrochloride), polyethylenimine, quaternary ammonium-functionalized graphene oxide, pyridinium-functionalized graphene oxide, amine-functionalized graphene oxide, their salts and mixtures thereof.

30. The membrane of claim 1, wherein the polymer layer comprises a polymer selected from polyacrylonitrile, polysulfone, polyethersulfone, polyester, polyvinylidene difluoride, polyimide, polyether ether ketone and mixtures thereof.

31. The membrane of claim 1, wherein the polymer layer comprises a polymer selected from polyacrylonitrile, poly(acrylonitrile-co-methyl acrylate), poly(2-acrylamido-2-methyl-1-propanesulfonic acid-co-acrylonitrile), and mixtures thereof.

32. The membrane of claim 1, wherein the polymer layer comprises greater than 5 weight percent poly(2-acrylamido-2-methyl-1-propanesulfonic acid-co-acrylonitrile).

33. The membrane of claim 1, wherein the molecular weight of the polymer layer is greater than 100 kDa.

34. The membrane of claim 1, wherein the non-woven fibrous support comprises a polymer selected from polyester, polyethylene, polypropylene and mixtures thereof.

35. A method for the production of a membrane, said method comprising:
depositing a polymeric solution comprising a polymer and a first solvent in which the polymer is soluble on a fibrous support to produce a film having a thickness from about 50 to 300 microns on the fibrous support;
immersing the fibrous support and film of polymeric solution in a non-solvent bath in which the polymer is insoluble, wherein the non-solvent bath induces a non-solvent phase separation of the polymeric solution to yield a porous substrate comprising the fibrous support coated with the polymer; and
depositing at least three alternating layers of polycationic and polyanionic solutions with layer thicknesses of 4 to 35 microns on the porous substrate to form charged material layers.

36. The method for the production of a membrane of claim 35, wherein the fibrous support comprises a non-woven fibrous support.

37. The method for the production of a membrane of claim 35, wherein three alternating layers of polycationic and polyanionic solutions are deposited on the porous substrate.

38. The method for the production of a membrane of claim 35, wherein four alternating layers of polycationic and polyanionic solutions are deposited on the porous substrate.

39. The method for the production of a membrane of claim 35, wherein five layers of alternating polycationic and polyanionic solutions are deposited on the porous substrate.

40. The method for the production of a membrane of claim 35, wherein six layers of alternating polycationic and polyanionic solutions are deposited on the porous substrate.

41. The method for the production of a membrane of claim 35, wherein the polycationic and polyanionic solutions each have a layer thickness of 6 to 25 microns.

42. The method for the production of a membrane of claim 35, wherein the polycationic and polyanionic solutions each have a layer thickness of 6 to 15 microns.

43. The method for the production of a membrane of claim 35, wherein the polycationic solution comprises a composition selected from poly(diallyldimethylammonium chloride), poly(vinylbenzyltrimethylammonium chloride, poly(acryloxyethyltrimethyl ammonium chloride), poly(methacryloxy(2-hydroxy)propyltrimethyl ammonium chloride), poly(N-methylvinylpyridinium), poly(allylamine hydrochloride), polyethylenimine, quaternary ammonium-functionalized graphene oxide, pyridinium-functionalized graphene oxide, amine-functionalized graphene oxide, their salts and mixtures thereof dissolved in water.

44. A method for the production of a membrane of claim 35, wherein the polyanionic solution comprises a composition selected from poly(styrenesulfonic acid), poly(vinylsulfonic acid), poly(2-acrylamido-2-methyl-1-propanesulfonic acid), sulfonated poly(ether ether ketone), poly(ethylenesulfonic acid), poly(methacryloxyethylsulfonic acid), poly(acrylic acid), poly(methacrylic acid), graphene oxide, sulfonic acid-functionalized graphene oxide, carboxyl-functionalized graphene oxide, molybdenum sulfide, boron nitride, their salts and mixtures thereof dissolved in water.

45. A method for the production of a membrane of claim 35, further comprising drying the porous substrate between deposition of the alternating layers of solution.
